(19) United States
(12) Patent Application Publication
(10) Pub. No.: US 2018/0229793 A1
(43) Pub. Date: Aug. 16, 2018

(54) Bicycle Crank Sprocket Guard

(71) Applicant: GATES CORPORATION, Denver, CO (US)

(72) Inventors: Michael Cody, Boulder, CO (US); Chris Vasiliotis, Denver, CO (US)

(21) Appl. No.: 15/431,453

(22) Filed: Feb. 13, 2017

(51) Int. Cl. B62J 13/00; F16H 55/30

(52) U.S. Cl. CPC B62J 13/00; F16H 55/30

(57) ABSTRACT

A crank arm comprising a crank arm receiving portion, a sprocket, a sprocket guard comprising a sprocket guard receiving portion, a nut engagable with a bolt fixing the sprocket to the crank arm receiving portion, and a third fastener engaging the sprocket guard receiving portion through the bolt.

### FIELD OF THE INVENTION

The invention relates to a bicycle crank sprocket guard, and more particularly, to a fastener nut engagable with a fastener bolt for fixing a sprocket to the crank arm receiving portion, and a third fastener engaging the sprocket guard receiving portion through the fastener bolt.

### BACKGROUND OF THE INVENTION

The drive portion of most bicycles comprise a crank arm, belt or chain, and rear sprocket. A rider engages pedals on the crank arm. A belt or chain engages the sprocket or chain ring on the crank arm. During use it is possible for the clothing of a rider to become caught between the belt or chain and the sprocket or chain ring. To prevent this various guards are known, each of which is fastened to the crank arm using differing methods.

Representative of the art is U.S. Pat. No. 3,815,439 which discloses a multi-speed transmission front gear system fixedly mounted to a crank shaft of a bicycle and provided with a plurality of different dent-numbered sprockets rotatable along with said crank shaft, chain guard members are mounted at each side of the minimum dent-numbered lowest speed transmission sprocket and the maximum dent-numbered highest speed transmission sprocket so that a driving chain can be prevented from getting off any selected one of said sprockets when shifted thereto, and further automatically shifted to such a sprocket even though the chain gets off the same.

What is needed is a bicycle crank sprocket guard comprising a fastener nut engagable with a fastener bolt for fixing a sprocket to the crank arm receiving portion, and a third fastener engaging the sprocket guard receiving portion through the fastener bolt. The present invention meets this need.

### SUMMARY OF THE INVENTION

The primary aspect of the invention is to provide a bicycle crank sprocket guard comprising a fastener nut engagable with a fastener bolt for fixing a sprocket to the crank arm receiving portion, and a third fastener engaging the sprocket guard receiving portion through the fastener bolt.

Other aspects of the invention will be pointed out or made obvious by the following description of the invention and the accompanying drawings.

The invention comprises a crank arm comprising a crank arm receiving portion, a sprocket, a sprocket guard comprising a sprocket guard receiving portion, a nut engagable with a bolt fixing the sprocket to the crank arm receiving portion, and a third fastener engaging the sprocket guard receiving portion through the bolt.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a cross-sectional view.

FIG. 2 is an exploded view.

FIG. 3 is an exploded view.

### DETAILED DESCRIPTION OF THE PREFERRED EMBODIMENT

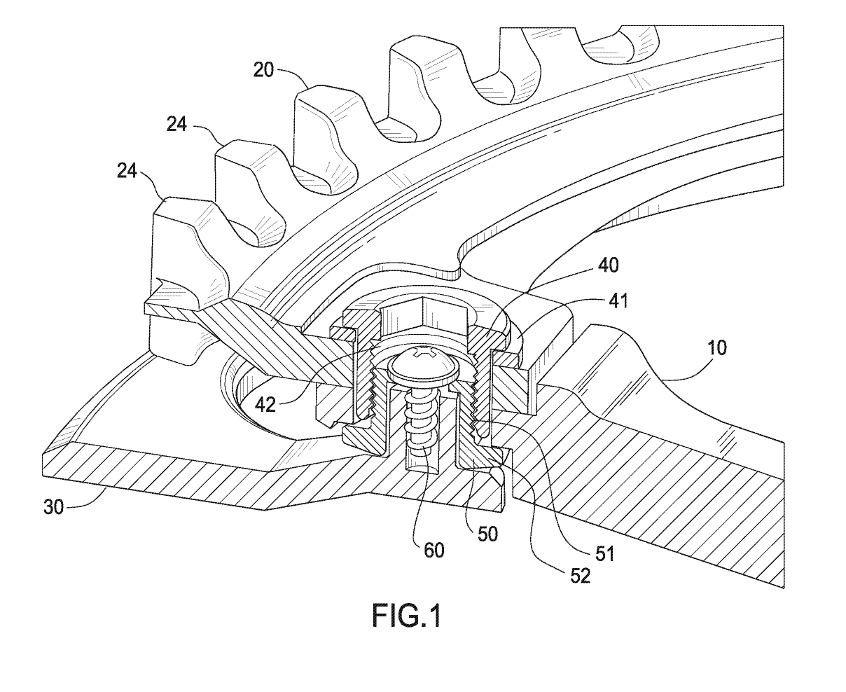

FIG. 1 is a cross-sectional view. The inventive device comprises crank arm 10. Sprocket 20 engages a belt (not shown). Sprocket 20 comprises transverse teeth 24. Sprocket guard 30 is fastened to the crank arm 10. Sprocket guard 30 is adjacent to sprocket 20 to prevent entrainment of a riders clothing between the sprocket and a belt (not shown). The crank arm is engagable with a bicycle frame bottom bracket (not shown).

Retention bolt 50 is threaded into retention nut 40 to fix sprocket 20 to crank arm 10. Sprocket 20 is clamped between retention nut 40 and retention bolt 50 on crank arm 10 through hole 21 and receiving portion 11. The external surface 51 of retention bolt 50 is threaded. The internal surface 42 of retention nut 40 is threaded to engage outer surface 51 of bolt 50. Retention bolt 50 comprises a flanged head 52 for retainably engaging the crank arm. Nut 40 may be fastened to bolt 50 using a hex key.

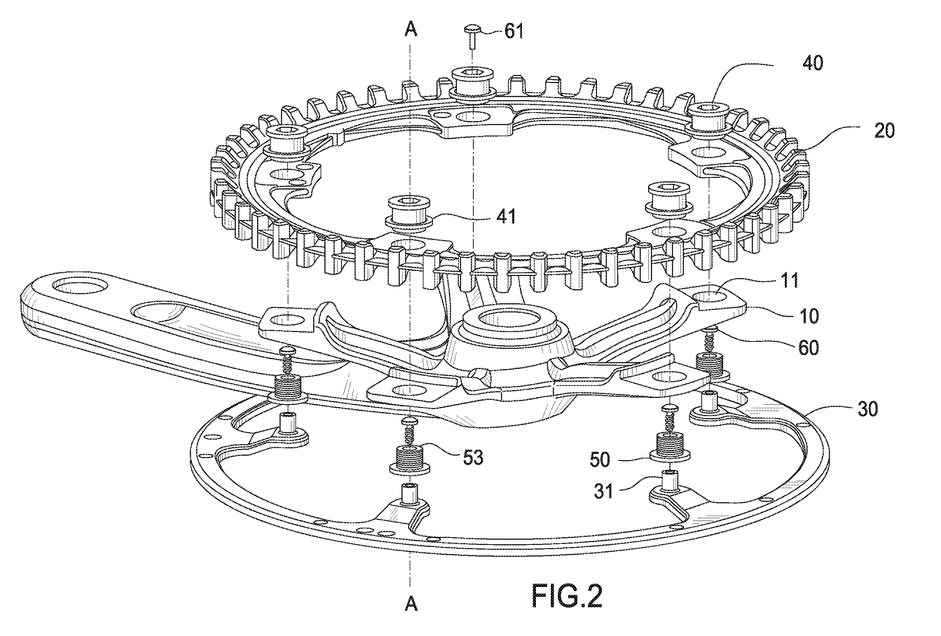

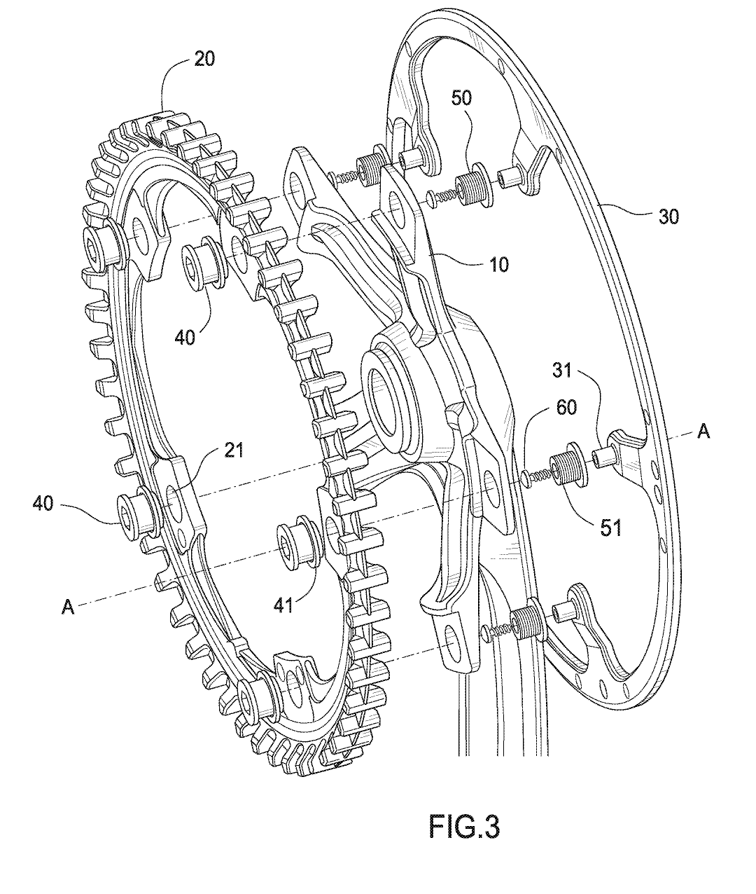

FIG. 2 is an exploded view. FIG. 3 is an exploded view. Fastener 60 threadably engages receiving portion 31 of guard 30. Receiving portion 31 is threaded. Fastener projects through a hole 53 in retention bolt 50 to engage receiving portion 31. In an alternate embodiment fastener 60 may be replaced with a rivet 61 with equal effect.

Retention nut 40, retention bolt 50 and fastener 60 are coaxially arranged along an axis A-A. Retention bolt 50 is nested within retention nut 40. Washer 41 is clamped between retention nut 40 and sprocket 20. Fastener 60 is nested within retention nut 40.

A crank arm comprising a crank arm receiving portion, a sprocket, a sprocket guard comprising a sprocket guard receiving portion, a nut engagable with a bolt fixing the sprocket to the crank arm receiving portion, and a third fastener engaging the sprocket guard receiving portion through the bolt.

The inventive system allows sprocket guard 30 to be removed without affecting the installation of the sprocket on the crank arm 10. It also allows retrofit of a sprocket guard to an original sprocket and crank arm set. For example, the sprocket guard may require replacement if damaged.

Although a form of the invention have been described herein, it will be obvious to those skilled in the art that variations may be made in the construction and relation of parts without departing from the spirit and scope of the inventions described herein.

I claim:

1. A crank arm comprising:
a crank arm receiving portion (11);
a sprocket (20);
a sprocket guard (30) comprising a sprocket guard receiving portion (31);
a nut (40) engagable with a bolt (50) fixing the sprocket to the crank arm receiving portion; and
a third fastener (60) engaging the sprocket guard receiving portion through the bolt.

2. The crank arm as in claim 1, wherein the third fastener comprises a threaded fastener.

3. The crank arm as in claim 1, wherein the sprocket guard receiving portion is threaded.

4. The crank arm as in claim 1, wherein the third fastener comprises a rivet.

5. The crank arm as in claim 1, wherein the nut and bolt and third fastener are coaxial.

6. The crank arm as in claim 1, wherein the bolt is threaded on an external surface.

7. The crank arm as in claim 1, wherein the nut is threaded on an internal surface.
